(19) United States
(12) Patent Application Publication
(10) Pub. No.: US 2025/0078333 A1
(43) Pub. Date: Mar. 6, 2025

(54) COMIC IMAGE GENERATION METHOD, COMPUTER DEVICE AND STORAGE MEDIUM

(71) Applicant: Beijing Zitiao Network Technology Co., Ltd., Beijing (CN)

(72) Inventors: Zheng LIU, Beijing (CN); Xinhui LEI, Beijing (CN); Zixuan WEI, Beijing (CN); Zixiu XUE, Beijing (CN); Fei DING, Beijing (CN); Qi SONG, Beijing (CN); Qi WANG, Beijing (CN); Tian GE, Beijing (CN); Qiuye CAO, Beijing (CN); Yuxuan YAN, Beijing (CN); Panxin YANG, Beijing (CN); Xiawen LIANG, Beijing (CN); Hongyue ZHAO, Beijing (CN); Jiayi SHEN, Beijing (CN)

(21) Appl. No.: 18/793,732

(22) Filed: Aug. 2, 2024

(30) Foreign Application Priority Data
Aug. 31, 2023 (CN) 202311118784.3

(51) Int. Cl. G06T 11/00; G06T 7/70; G06T 19/20

(52) U.S. Cl. CPC G06T 11/00; G06T 7/70; G06T 19/20; G06T 2207/20044; G06T 2219/2016

(57) ABSTRACT

The present disclosure provides a comic image generation method and apparatus, a computer device, and a storage medium, and the method includes: acquiring pose text information corresponding to a comic storyboard, the pose text information being used for describing target action poses of at least one target object; determining a pose assistance image corresponding to the comic storyboard according to the pose text information, reference action poses of a reference object in the pose assistance image matching the target action poses; and generating comic images corresponding to the comic storyboard using an artificial intelligence model according to the pose text information and the pose assistance image, target objects in the comic images having the target action poses.

### CROSS-REFERENCE TO RELATED APPLICATION

The present application claims the priority to Chinese Patent Application No. 202311118784.3, filed on Aug. 31, 2023, the entire disclosure of which is incorporated herein by reference as portion of the present application.

### TECHNICAL FIELD

The present disclosure relates to the field of computer technology, in particular to a comic image generation method and apparatus, a computer device, and a storage medium.

### BACKGROUND

Comics have gained widespread popularity among readers due to their ability to convey ideas in a straightforward and engaging manner, sparking a growing trend in converting high-quality text content into comics. The conventional process of converting text content into comics usually involves dividing the text content into multiple comic storyboards and generating a corresponding comic image for each comic storyboard based on the corresponding text content. However, the resulting comic images generated using this method often suffer from inaccuracies, compromising the generation effect of the comic images.

### SUMMARY

The embodiments of the present disclosure provide a comic image generation method, an apparatus, a computer device, and a storage medium.

In a first aspect, the embodiments of the present disclosure provide a comic image generation method, including:
acquiring pose text information corresponding to a comic storyboard, the pose text information being used for describing target action poses of at least one target object;
determining a pose assistance image corresponding to the comic storyboard according to the pose text information, reference action poses of a reference object in the pose assistance image matching the target action poses; and
generating comic images corresponding to the comic storyboard using an artificial intelligence model according to the pose text information and the pose assistance image, target objects in the comic images having the target action poses.

In a possible implementation, determining the pose text information includes:
acquiring a target novel to be converted into a comic;
splitting the target novel according to novel content of the target novel to obtain comic text information of each comic storyboard corresponding to the target novel, the comic text information containing text keywords of the comic storyboard under multiple image generation dimensions; and
generating the pose text information corresponding to the comic storyboard according to the text keywords in the comic text information.

In a possible implementation, the generating the pose text information corresponding to the comic storyboard according to the text keywords in the comic text information includes:
screening out at least one target keyword related to the target action poses of the target object from the text keywords; and
generating the pose text information according to at least one target keyword.

In a possible implementation, the determining the pose assistance image corresponding to the comic storyboard according to the pose text information includes:
searching for the pose assistance image matching the target action poses of at least one target object from a picture information library according to the pose text information and/or the text keywords corresponding to the pose text information.

In a possible implementation, the generating comic images corresponding to the comic storyboard using the artificial intelligence model according to the pose text information and the pose assistance image includes:
in response to the existence of an object generation model matching the target object, calling the object generation model to obtain a target object image;
performing image recognition on the pose assistance image using a pose recognition model to obtain the reference action poses; and
generating the comic images using the artificial intelligence model according to the target object image, the reference action poses, and the pose text information.

In a possible implementation, the pose assistance image includes a skeletal point image; and
the determining the pose assistance image corresponding to the comic storyboard according to the pose text information includes:
acquiring an initial three-dimension (3D) skeletal point model;
performing pose adjustment on the initial 3D skeletal point model according to the target action poses of at least one target object to obtain a target 3D skeletal point model corresponding to each target object; and
determining the skeletal point image according to the target 3D skeletal point model.

In a possible implementation, the target action poses include a first action pose of the target object and a second action pose when the target object interacts with props; the reference action poses include a first reference pose matching the first action pose and a second reference pose matching the second action pose; and
the generating comic images corresponding to the comic storyboard using the artificial intelligence model according to the pose text information and the pose assistance image includes:
performing skeletal point recognition on the reference object in the pose assistance image using an artificial intelligence model by calling a skeletal point recognition function, to obtain the first reference pose, and performing contour recognition on the reference object in the pose assistance image by calling a contour recognition function, to determine the second reference pose; and
generating the comic images corresponding to the comic storyboard according to the first reference pose, the second reference pose and the pose text information, in which the target objects in the comic image have the first action pose and the second action pose.

In a possible implementation, the determining the pose assistance image corresponding to the comic storyboard according to the pose text information includes:
determining pose types of the target action poses described in the pose text information; and
determining the pose assistance image according to the pose text information in a case where the pose types meet a preset type condition, in which the preset type condition is used for indicating a pose type that the target action poses need to conform to when the pose assistance image needs to be used.

In a possible implementation, the method further including:
acquiring background text information corresponding to the comic storyboard, the background text information being used for indicating a target image background corresponding to the comic storyboard;
in which the generating comic images corresponding to the comic storyboard using the artificial intelligence model according to the pose text information and the pose assistance image includes:
generating the comic images using the artificial intelligence model according to the pose text information, the pose assistance image, and the background text information,
in which the target objects in the comic image have the target action poses and the comic images have the target image background.

In a second aspect, the embodiments of the present disclosure further provide a comic image generation apparatus, including:
an acquisition module, configured to acquire pose text information corresponding to a comic storyboard, the pose text information being used for describing target action poses of at least one target object;
a first determination module, configured to determine a pose assistance image corresponding to the comic storyboard according to the pose text information, reference action poses of a reference object in the pose assistance image matching the target action poses; and
a generation module, configured to generate comic images corresponding to the comic storyboard using an artificial intelligence model according to the pose text information and the pose assistance image, target objects in the comic images having the target action poses.

In a third aspect, the optional implementation of the present disclosure further provides a computer device, including a processor and a memory, in which the memory stores machine-readable instructions executable by the processor, the processor is used for executing the machine-readable instructions stored in the memory, and when the machine-readable instructions are executed by the processor, the processor executes the steps in the above-mentioned first aspect, or any possible implementation of the first aspect.

In a fourth aspect, the optional implementation of the present disclosure further provides a non-transitory computer-readable storage medium, in which a computer program is stored on the non-transitory computer-readable storage medium, and when the computer program is run on a computer device, the computer device executes the steps in the above-mentioned first aspect, or any possible implementation of the first aspect.

### BRIEF DESCRIPTION OF DRAWINGS

In order to more clearly illustrate the technical solutions of the embodiments of the present disclosure, the drawings required for the embodiments are briefly described below. These drawings are incorporated into and constitute a part of the present disclosure. These drawings illustrate embodiments that comply with the present disclosure and, together with the detailed description, serve to explain the technical solutions of the present disclosure. It should be understood that the following drawings only show some embodiments of the present disclosure and therefore should not be considered as limiting its scope. For those skilled in the art, other related drawings may also be obtained based on these drawings without any creative effort.

FIG. 1 is a flow chart of a comic image generation method according to an embodiment of the present disclosure;

FIG. 2 is a schematic diagram of a pose assistance image, pose text information, and a comic image according to an embodiment of the present disclosure;

FIG. 3 is a schematic diagram of a skeletal point image and comic images according to an embodiment of the present disclosure;

FIG. 4 is a schematic diagram of a comic image generation apparatus according to an embodiment of the present disclosure; and

FIG. 5 is a structural schematic diagram of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure will be described clearly and completely below in conjunction with the drawings. Apparently, the described embodiments are just a part but not all of the embodiments of the present disclosure. The components of the embodiments of the present disclosure typically described and illustrated herein can be arranged and designed in a variety of different configurations. Therefore, the detailed description of the embodiments of the present disclosure provided below is not intended to limit the scope of the present disclosure as claimed, but merely represents selected embodiments of the present disclosure. All other embodiments obtained by those skilled in the art without any creative effort based on the embodiments of the present disclosure fall within the scope of the present disclosure.

The terms such as “first” and “second” in the description, claims or above-mentioned drawings in the embodiments of the present disclosure are intended to distinguish between similar objects and are not necessarily to describe a specific order or sequence. It should be understood that the terms used in this way are interchangeable under appropriate circumstances, so that the embodiments described herein can be implemented in other orders than those illustrated or described herein.

As used herein, “multiple or several” refers to two or more. The term “and/or” herein signifies an association relationship between associated objects, denoting the possibility of three different relationship types. For example, A and/or B may mean A alone; A and B; and B alone. The character “/” generally indicates that the associated objects have an “or” relationship.

It has been found that in the production process of converting novels into comics, it is usually necessary to conduct storyboarding on the novel content first to obtain comic storyboards corresponding to the novel content and key text information for each comic storyboard. After obtaining the key text information, comic character images corresponding to each comic storyboard can be drawn based on the key text information. However, conventional methods of drawing comic character images suffer from low efficiency and poor accuracy.

Based on the above research, the present disclosure provides a comic image generation method and apparatus, a computer device and a storage medium. Because pose text information is used to describe target action poses of target objects, and a reference object in a pose assistance image has reference action poses that match the target action poses, after the pose text information is acquired, generating comic images by determining the pose assistance image and combining the pose text information and the pose assistance image can improve the diversity of reference information available to an artificial intelligence model for generating the comic images including a target object having the target action poses, so as to enhance the accuracy of action poses generated by the artificial intelligence model and the accuracy of the comic images. That is, by combining the pose text information and the pose assistance image to generate the comic images, the embodiments of the present disclosure may realize the characterization of the target action poses by using information from multiple angles, so that the accuracy of the action poses of the target object generated in the comic images is effectively improved, and the accurate and reasonable comic images corresponding to the comic storyboard is obtained.

The defects of the above-mentioned solution are the result of the inventor's practice and careful study, and therefore, the process of discovering the above-mentioned problem and the solution proposed in the present disclosure below to address the above-mentioned problem should be the inventor's contribution to the present disclosure in the course of the present disclosure.

It should be noted that similar signs and letters denote similar items in the following drawings, and therefore, once an item is defined in a figure, it does not need to be further defined or explained in the subsequent figures.

It may be understood that before using the technical solutions disclosed in the embodiments of the present disclosure, it is necessary to inform user(s) of the types, using scope, and using scenarios of personal information involved in the present disclosure according to relevant laws and regulations in an appropriate manner and obtain the authorization of the user(s).

It should be noted that specific terms mentioned in the embodiments of the present disclosure include:
prompt, is an artificial intelligence (AI) prompt word. It is a method that uses natural language to guide or stimulate an artificial intelligence model to complete specific tasks. The purpose of a prompt is to offer the AI model hints regarding the context of input information and the parameters of an input model, allowing the model to better comprehend the input's intent and provide the appropriate output.

To facilitate the understanding of the embodiments, firstly, a comic image generation method disclosed in an embodiment of the present disclosure is introduced in detail. The executive subject of the comic image generation method provided in the embodiment of the present disclosure is generally a terminal device with certain computing power or other processing devices. The terminal device may be a user equipment (UE), a mobile device, a user terminal, a terminal, a personal digital assistant (PDA), a handheld device, a computer device, etc. In some possible implementations, the comic image generation method may be realized by a processor invoking computer-readable instructions stored in memory.

Next, the comic image generation method provided by the embodiment of the present disclosure will be explained by taking a computer device as the executive subject.

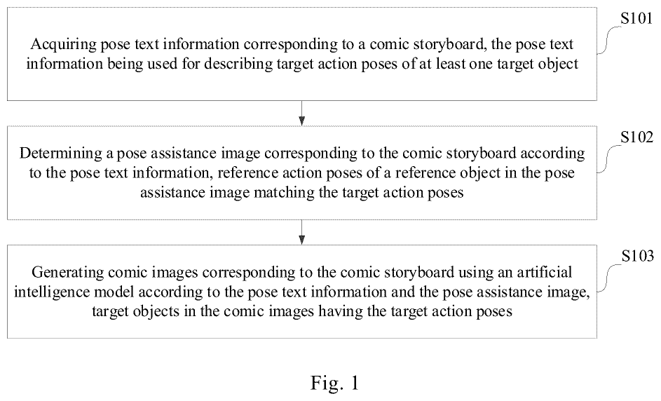

As shown in FIG. 1, which is a flow chart of a comic image generation method according to an embodiment of the present disclosure, the method may include the following steps.

S101: acquiring pose text information corresponding to a comic storyboard, the pose text information being used for describing target action poses of at least one target object.

Comic storyboarding may be understood as a process of summarizing and designing a comic story based on factors such as time, characters, sequence, and structure, used to represent the storyline of the comic. The quality of a comic storyboard directly affects the quality of generated comic images, with each comic storyboard corresponding to an individual comic image within the comic.

A comic storyboard may include at least one target object. The target action poses are action poses possessed by the target object(s), such as various expressions, raising hands, shaking hands, bending, bowing, lifting legs, etc. The pose text information may be text information related to the action poses of the various target objects in the comic storyboard, used to describe the target action poses possessed by at least one target object in the comic storyboard.

In response to the existence of only one target object, the target action poses described by the pose text information are the action poses of the target object; and in response to the existence of multiple target objects, the target action poses described by pose text information may not only represent the action poses of each target object, but also represent interactive action poses between the target objects.

The pose text information may be generated according to the comic story content of a comic to be generated. For example, the comic story content may be storyboarded to obtain the comic storyboards corresponding to the comic story content. Then, for each comic storyboard, keywords under various dimensions related to the comic images corresponding to the comic storyboard may be extracted from the comic story content, and then the keywords are converted into dimensional information that can be understood by the artificial intelligence model. Then, the dimensional information may be used as the pose text information, or the pieces of dimensional information related to the target object of the comic storyboard in these pieces of dimensional information may be combined as the pose text information.

It is easy to understand that in the field of text-to-image conversion, the pose text information is a pose prompt used to describe the target action poses of at least one target object, and the pose prompt may be used as the prompt information of the artificial intelligence model to help the artificial intelligence model generate an image represented by the pose prompt.

In one embodiment, for novels of various genres, there may be a need to generate comics by using novels or compelling plots in novels. In this case, the pose text information may be generated according to the novel content of the novel. Specifically, the pose text information may be determined according to the following steps.

Step 1: acquiring a target novel to be converted into a comic.

The target novel may be any genre of novel used for generating a webtoon. Alternatively, the target novel may also be chapters selected from any novel.

Step 2: splitting the target novel according to novel content of the target novel to obtain comic text information of each comic storyboard corresponding to the target novel, the comic text information containing text keywords of the comic storyboard under multiple image generation dimensions.

The image generation dimensions may be predetermined information dimensions, and the text keywords under different image generation dimensions are used for representing the characteristic information of the comic storyboard from different angles. As an example, the image generation dimensions may include at least characters, scenes, props, clothing, time, ambient light, camera language, scenery, perspectives, expressions, actions, human-object interaction, human-human interaction, object-object interaction, dialogue, interior monologue, etc. There may be one or more text keywords under one image generation dimension.

In a concrete implementation, after obtaining the target novel, the target novel may be split based on the chapters and content to extract various novel segments corresponding to the target novel. Each novel segment corresponds to one comic storyboard. Subsequently, for each novel segment, text keywords corresponding to each comic storyboard under various image generation dimensions may be extracted based on the text content of the novel segment, thereby obtaining comic text information corresponding to the comic storyboard.

Step 3: generating the pose text information corresponding to the comic storyboard according to the text keywords in the comic text information.

In a concrete implementation, for each comic storyboard, each text keyword in the comic text information corresponding to the comic storyboard may be standardized to obtain standard text information corresponding to each text keyword. The standardization processing may convert the text keywords into information that can be understood by the artificial intelligence model. The standard text information obtained after the standardization processing may be understood as prompts corresponding to the text keywords. After that, the standard text information corresponding to the comic storyboard may be used as the pose text information corresponding to the comic storyboard.

For example, each of multiple standard text information may be separately regarded as the pose text information, or multiple standard text information may be spliced according to preset splicing rules to obtain the pose text information.

In one embodiment, in order to further reduce the information amount of the pose text information corresponding to the comic storyboard, reduce the difficulty of model processing, and improve the speed of model processing, the text keywords may be screened, and the pose text information is determined based on the screened text keywords. Specifically, the above step 3 may be implemented by the following sub-steps.

Sub-step 1: screening out at least one target keyword related to the target action poses of the target object from the text keywords.

The target keywords are text keywords used for representing action poses and object attributes, and the object attributes may include information such as the age, gender, skin color, hair color, height, clothing, etc. of the object.

In a concrete implementation, for any comic storyboard, after obtaining the text keywords of a comic text under multiple image generation dimensions, at least one target keyword that can be used for representing the target object and its target action poses may be screened out from the text keywords according to the correlation between each text keyword and the action poses and object attributes. Alternatively, a target dimension may be determined from the image generation dimensions according to the correlation between each image generation dimension and the action poses and object attributes, and each text keyword under the target dimension may be used as the target keyword.

Sub-step 2: generating the pose text information according to at least one target keyword.

In a concrete implementation, after screening out at least one target keyword corresponding to each comic storyboard, each target keyword may be standardized respectively to obtain standard text information corresponding to each target keyword. Then, each piece of standard text information may be regarded as the pose text information, or different pieces of standard text information may be spliced to obtain the pose text information. Based on this, it can be understood that the pose text information is used for representing object action characteristics and object attribute characteristics corresponding to the comic storyboard respectively under multiple image generation dimensions.

It should be noted that in order to allow the artificial intelligence model to better understand the pose text information, the pose text information may be information in a specific language, such as Chinese and/or English.

For example, the pose text information may be pose text information 1:
“2girls, hugging another, masterpiece, white background, AND 2girls, yellow dress, black hair, blue eyes, hugging another, facing another <character name 1>, AND 2girls, ponytail, pencil skirt, bangs, brown hair, glasses, hugging another, facing another <character name 2>”.

In S102: determining a pose assistance image corresponding to the comic storyboard according to the pose text information, reference action poses of a reference object in the pose assistance image matching the target action poses.

The pose assistance image is an image used for assisting the artificial intelligence model in generating comic images, which may include reference object(s) with reference action poses. The reference action poses are the same as the target object poses of the target object in the comic storyboard, or the similarity between the two is greater than a preset threshold. The number of the reference objects is the same as the number of the target objects in the comic storyboard, one reference object corresponds to one target object, and the reference action poses of the reference object are determined by the target action poses of the corresponding target object.

The reason for using the pose assistance image is that using pose prompts alone for generating comic images does not guarantee a one-to-one relationship between the pose prompts and the action poses. Moreover, there may be issues with inadequate depiction, especially when it comes to complex action poses, which results in deviations in the action of the target object in the generated comic image, thus compromising the accuracy of the generated comic image. For example, when it comes to the target action pose of turning one's head, using pose prompts alone cannot accurately describe factors such as the angle and direction of the head turn, and poses of other body parts during the head turn. Therefore, relying solely on pose prompts for image generation would impair the accuracy of the generated images.

Therefore, in the embodiments of the present disclosure, on the basis of using the pose text information, the pose assistance image is also used, so as to express the target action poses of the target object by means of the reference object in the pose assistance image. In this way, the artificial intelligence model may combine the pose text information and the pose assistance image to generate comic images, thus improving the accuracy of the generated action poses, and further improving the accuracy of the generated comic images.

In a concrete implementation, the pose assistance image with more action pose details may be found according to the number of target objects indicated by the pose text information, and the target action poses of the target objects. Here, more action pose details may be, for example, additional details of target parts corresponding to the target action poses, as well as details of other parts aside from the target parts. For example, when the pose text information specifies the target action pose of the target object is crossing arms over the chest, the reference object in the identified pose assistance image may not only have the action of crossing arms over the chest, but also include details such as the height of crossing the arms, the distance from the chest, the front and back relationship of the hands, the finger details of each finger and the position on the arms, the head angle and posture when crossing the arms, and the body tilt angle.

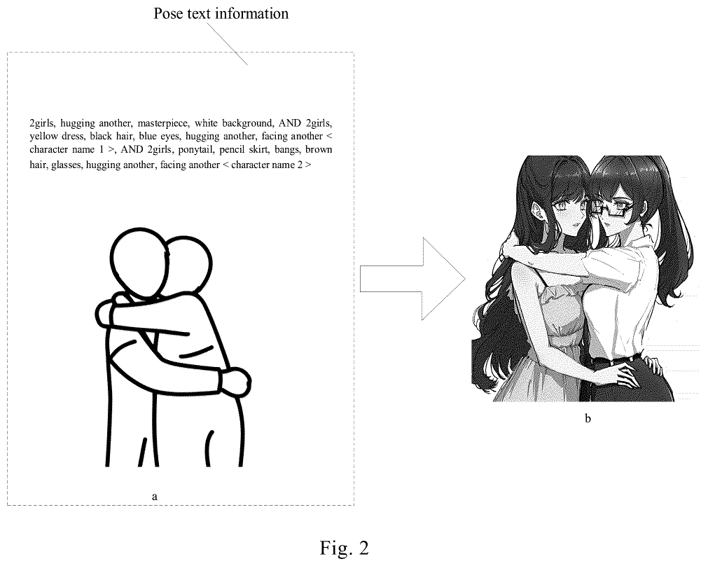

For example, as shown in FIG. 2 which is a schematic diagram of a pose assistance image, pose text information, and a comic image according to an embodiment of the present disclosure, the pose text information is pose text information 1, the pose assistance image is shown as a in FIG. 2, and the generated comic image is shown as b in FIG. 2.

In one embodiment, in some cases, the pose text information may realize accurate control of a specific type of action poses. This type of action poses can ensure that the artificial intelligence model generates comic images with high accuracy without using the pose assistance image. Therefore, in a concrete implementation, before determining the pose assistance image, whether it is necessary to use the pose assistance image is determined. Specifically, pose types of the target action poses described in the pose text information may be determined first; and then, in the case where the pose types meet a preset type condition, the pose assistance image may be determined according to the pose text information. Here, the preset type condition is used for indicating the pose types that the target action poses need to conform to when the pose assistance image needs to be used.

Here, the pose types may include facial pose, limb pose, body pose, head pose, and so on. For the facial pose, the pose text information has a controlling effect that allows for the accurate generation of corresponding comic images without the need for the pose assistance image. Therefore, the preset type condition may be that the pose assistance image needs to be used when the pose type is anything other than the facial pose.

For example, after the pose text information is obtained, the pose type of each target action pose indicated by the pose text information may be determined first, and in response to the facial pose being the only pose type, it is determined that the pose assistance image is not needed. Therefore, the pose text information may be directly input into the artificial intelligence model, and then the accurate comic images are obtained.

On the contrary, in response to the pose types not including the facial pose, or including both the facial pose and other pose types, it means that the above-mentioned preset type condition is met, and then the pose assistance image may be determined according to the pose text information and/or the text keywords corresponding to the pose text information.

In one embodiment, S102 may be implemented according to the following steps:
searching for the pose assistance image matching the target action poses of at least one target object from a picture information library according to the pose text information and/or the text keywords corresponding to the pose text information.

Here, the text keywords corresponding to the pose text information are text keywords used for generating the pose text information. The picture information library may be a dynamic-dimensional image library, which includes a plurality of action pose images, each action pose image may include one or more objects, and each object may be an actual captured object and may have any action pose.

In a concrete implementation, a picture search platform may be provided in advance, which is connected with a picture information library. After obtaining the pose text information corresponding to the comic storyboard, the pose text information and/or the text keywords corresponding to the pose text information may be directly used to conduct a picture search on the picture search platform, so as to extract the pose assistance image matching the comic storyboard from the picture information library. Alternatively, some keywords may be screened out from the pose text information and/or the text keywords corresponding to the pose text information, and the selected keywords may be used to conduct a picture search on the picture search platform, so as to extract the pose assistance image from the picture information library.

Alternatively, in response to the pose text information being generated according to the comic story content or the text content in the novel segment, it is also possible to use the comic story content corresponding to the pose text information or the text content in the corresponding novel segment corresponding to the pose text information to conduct a picture search on the picture search platform, so as to obtain the pose assistance image.

Alternatively, the pose assistance image may also be drawn manually according to the pose text information and/or the text keywords corresponding to the pose text information.

S103: generating comic images corresponding to the comic storyboard using an artificial intelligence model according to the pose text information and the pose assistance image, target objects in the comic images having the target action poses.

Here, the artificial intelligence model may be a pre-trained neural network model, which may be used for generating comic images according to input prompts and images. The generated comic images include the target objects indicated by the pose text information, each target object has the target action poses, and the target action poses are generated according to the pose text information and the reference action poses in the pose assistance image.

In a concrete implementation, for any comic storyboard, after obtaining the pose text information and the pose assistance image corresponding to the comic storyboard, the pose text information and the pose assistance image may be input into the artificial intelligence model together to obtain comic images output by the artificial intelligence model.

It can be understood that in response to the pose text information being a single piece of standard text information, it is also possible to splice all the pose text information before inputting the pose text information into the artificial intelligence model, so as to obtain spliced pose text information. Then, the spliced pose text information and the pose assistance image may be input into the artificial intelligence model together, so as to obtain the comic images.

Alternatively, because the artificial intelligence model exhibits randomness when outputting comic images, the number of comic images output by the artificial intelligence model at a time may also be preset. Each comic image is generated by using the pose text information and the pose assistance image, but there may be subtle differences between comic images. For example, the artificial intelligence model can output three comic images at a time.

Then, from the output comic images, one with the highest quality and the highest matching degree with the comic text information may be selected as the final comic image corresponding to the comic storyboard.

To further improve the accuracy of the comic images corresponding to the comic storyboard, after the comic images output by the artificial intelligence model are obtained, the comic images may be manually modified, so as to improve the accuracy and reasonableness of the final comic image.

In this way, because pose text information may be used to describe target action poses of target objects, and reference objects in the pose assistance image have reference action poses that match the target action poses, after the pose text information is acquired, generating comic images by determining the pose assistance image and combining the pose text information and the pose assistance image can improve the diversity of reference information available to an artificial intelligence model for generating the comic image including target objects having the target action poses, so as to enhance the accuracy of action poses and the accuracy of the comic images that are generated by the artificial intelligence model. That is, by combining the pose text information and the pose assistance image to generate the comic images, the embodiments of the present disclosure may realize the characterization of the target action poses by using information from multiple angles, so that the accuracy of the action poses of the target objects generated in the comic images is effectively improved, and the accurate and reasonable comic images corresponding to the comic storyboard are obtained.

In one embodiment, the pose assistance image may include a skeletal point image, in which case, the above S102 may be implemented according to the following steps:
acquiring an initial 3D skeletal point model; performing pose adjustment on the initial 3D skeletal point model according to the target action poses of at least one target object to obtain a target 3D skeletal point model corresponding to each target object; and determining the skeletal point image according to the target 3D skeletal point model.

Here, the initial 3D skeletal point model may be a 3D model that can be adjusted at will.

In a concrete implementation, a pre-stored 3D skeletal point model may be obtained as the initial 3D skeletal point model, or a 3D character model obtained from any authorized model channel may be used as the initial 3D skeletal point model. Here, the number of the initial 3D skeletal point models may be determined according to the number of the target objects indicated by the pose text information.

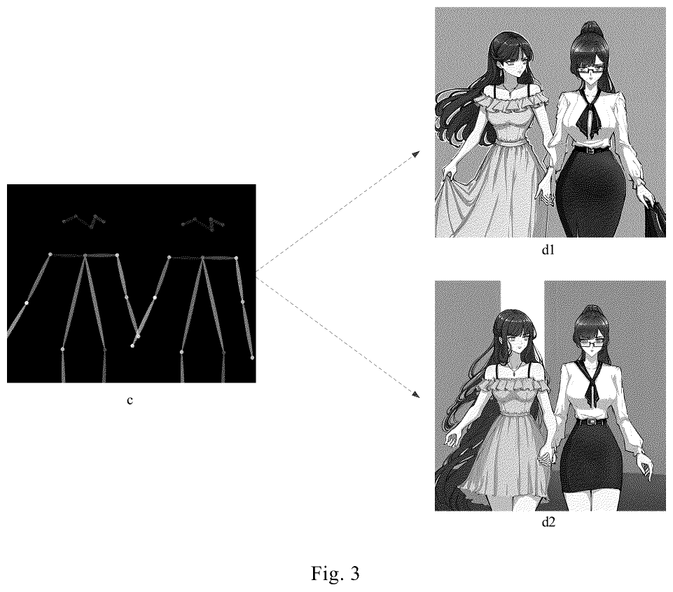

After obtaining the initial 3D skeletal point model, skeletal point positions of the initial 3D skeletal point model may be adjusted according to the target action poses of each target object, so as to obtain the target 3D skeletal point model with the target action poses. Here, in response to the existence of multiple target objects and there being action interaction between these target objects, the initial 3D skeletal point models of multiple target objects may be adjusted synchronously to obtain a group of target 3D skeletal point models with interaction. One target 3D skeletal point model corresponds to one reference object. In response to the existence of only one target object, the one corresponding to the target object may be directly used as a group of target 3D skeletal point models. Then, the group of target 3D skeletal point models may be subjected to dimensionality reduction, so as to obtain a 2D skeletal point image, which may be used as a pose assistance image. As shown in FIG. 3 which is a schematic diagram of a skeletal point image and comic images according to an embodiment of the present disclosure, c is a skeletal point image, including skeletal point models corresponding to two reference objects, d1 and d2 are comic images output by the artificial intelligence model, and both comic images include two target objects with the target action poses. For d1 and d2, d2 may be regarded as the final comic image corresponding to the comic storyboard.

It can be understood that in response to the target action poses including a first action pose of the target object, and a second action pose when the target object interacts with props, not only can the initial 3D skeletal point model be used to obtain a skeletal point image matching the first action pose and the second action pose, but also a contour image related to an action contour corresponding to the second action pose can be determined according to the second action pose. Then, the skeletal point image and the contour image may be both used as the pose assistance image. Here, the first action pose is an action pose of the target object, and the second action pose is an overall pose when the target object interacts with the props.

In one embodiment, S103 may be implemented according to the following steps.

S103-1: in response to the existence of an object generation model matching the target object, calling the object generation model to obtain a target object image.

Here, the object generation model is a pre-trained neural network model dedicated to generating the target object, and each object generation model can be called by the artificial intelligence model. Specifically, the various target objects for which the corresponding object generation model needs to be trained can be determined based on the reusability of the target object. Here, the reusability is determined according to the number of times the target object appears in different comic storyboards and the total number of comic storyboards.

In a concrete implementation, after the pose text information and the pose assistance image are input into the artificial intelligence model, it may be determined first whether there is a matching object generation model for the target object indicated by the pose text information. If so, the object generation model may be directly called and a target object image output by the object generation model is obtained. If not, the artificial intelligence model may be directly used to generate comic images with the target object according to the reference action poses and pose text information recognized by a pose recognition model as described later.

S103-2: performing image recognition on the pose assistance image using a pose recognition model to obtain the reference action poses.

Here, the pose recognition model is a model for recognizing the pose of the reference object in the image, and can also be called by the artificial intelligence model.

In a concrete implementation, the artificial intelligence model may be used to call the pose recognition model for image recognition of the pose assistance image, so as to recognize each reference object in the pose assistance image and the reference action poses corresponding to each reference object.

S103-3: generating the comic images using the artificial intelligence model according to the target object image, the reference action poses and the pose text information, the target objects in the comic image having the target action poses.

In a concrete implementation, after obtaining the target object image and the reference action poses, the artificial intelligence model may be used to adjust the poses of the target object in the target object image according to the reference action poses and the pose text information, so as to obtain the target object with the target action poses, and then the comic images may be generated according to the target object and the pose text information.

In one embodiment, for any comic storyboard, the target object in the comic storyboard may be a single object, which can interact with other objects in the comic storyboard, and can also interact with items, props and the like in the comic storyboard. When the target object interacts with other objects or props, the target action poses of the target object may be subdivided into two parts, one part is a first action pose of the target object itself, and the other part is a second action pose when the target object interacts with props. Here, the second action pose includes more information, such as the poses and shapes of the props, than the first action pose. In response to the target action poses including the first action pose and the second action pose, the reference action poses of the reference object in the pose assistance image may also be divided into two parts, one is a first reference pose matching the first action pose, and the other is a second reference pose matching the second action pose. The first reference pose includes more action details and pose details than the first action pose on the basis that it is consistent with the first action pose or the similarity is greater than a preset threshold. The second reference pose includes more action details and pose details than the second action pose on the basis that it is consistent with the second action pose or the similarity is greater than a preset threshold. These details include the details corresponding to the target object and the details corresponding to the props.

S103 may be implemented according to the following steps.

S1031: performing skeletal point recognition on the reference object in the pose assistance image using an artificial intelligence model by calling a skeletal point recognition function, to obtain the first reference pose, and performing contour recognition on the reference object in the pose assistance image by calling a contour recognition function, to determine the second reference pose.

Here, the skeletal point recognition function is for recognizing each skeletal point of the object in the image, and the skeletal point recognition function may be called through a plug-in corresponding to the skeletal point recognition function. The contour recognition function is for recognizing the contour of each object in the image, and may also be called through a corresponding plug-in.

In a concrete implementation, because the props have no skeletal points, it is impossible to recognize the poses of the props if only the skeletal point recognition function is used. Therefore, in response to the target action poses also including the second action pose when interacting with props, the artificial intelligence model may be used to call the skeletal point recognition function and the contour recognition function, respectively. Then, the skeletal point recognition function is used for object recognition of the pose assistance image, to determine each reference object in the pose assistance image, and then the reference object is subjected to skeletal point recognition, so as to obtain the first reference poses of the reference object. At the same time, the contour recognition function may be used for contour recognition of the pose assistance image, so as to determine second reference pose corresponding to the reference object and reference props in the pose assistance image.

Alternatively, if the pose assistance image includes the skeletal point image and the contour image, after the pose assistance image and the pose text information are input into the artificial intelligence model, the contour recognition function may be called first to recognize the contour image in the pose assistance image, so as to obtain the second reference pose. Then, the artificial intelligence model may be used to determine the first reference pose according to skeletal points in the skeletal point image.

In S1032, generating comic images corresponding to the comic storyboard according to the first reference pose, the second reference pose and the pose text information, the target objects in the comic image having the first action pose and the second action pose.

In a concrete implementation, the first reference pose, the second reference pose and the pose text information may be fused by using the artificial intelligence model, and the comic images corresponding to the comic storyboard are output based on a fusion result. Here, the comic images may include the target object and the props, and besides the first action pose of the target object, there is also the second action pose when the target object interacts with the props.

In this way, through the skeletal point recognition and contour recognition of the pose assistance image, it can avoid the problem of props or items without skeletal points not being recognized, resulting in the inability to generate the props and items, and the inability to generate poses when the target object interacts with them. This helps increase the accuracy of generated comic images and improves the precision of target object actions in the comic images.

In one embodiment, in response to the pose text information being directly generated according to the text keywords of the comic storyboard under multiple image generation dimensions, the pose text information may also directly include information related to the scene (i.e., background) of the comic storyboard. In this case, the artificial intelligence model may be directly used to generate a background image with information such as the background and the target object with the target action poses according to the pose text information and the pose assistance image. In response to the pose text information being generated according to the target keywords related to the target action pose of the target object, it indicates that the pose text information does not include the information related to the scene (i.e., background) of the comic storyboard. In this case, to ensure content integrity of the generated comic images, it is also necessary to obtain background text information corresponding to the comic storyboard. The background text information is used for indicating a target image background corresponding to the comic storyboard.

For S103, after obtaining the background text information, the comic images may be generated using the artificial intelligence model according to the pose text information, the pose assistance image, and the background text information. The target objects in the comic images have the target action poses and the comic images have the target image background.

Here, the target image background may be understood as the storyboard scene corresponding to the comic storyboard, such as a bus stop, office, hospital, seaside and so on. The background text information may be generated according to background keywords related to the image background selected from the text keywords in the comic text information. It is easy to understand that the background text information is a background prompt related to the scene of the comic storyboard.

In a concrete implementation, after obtaining the comic text information corresponding to each comic storyboard, the pose text information and the background text information may be generated according to the text keywords under each image generation dimension included in the comic text information.

Then, the pose assistance image may be determined according to the pose text information. The pose text information, the background text information and the pose assistance image are input into the artificial intelligence model together, and the pose text information, the pose assistance image, and the background text information are processed by using the artificial intelligence model, so as to generate the comic images including the props, the target objects with the target action poses, the target image background. In this way, the background accuracy of the generated comic images is improved by generating the comic images through the obtained background text information.

It can be understood by those skilled in the art that in the above-mentioned method according to concrete implementations, the order of writing the steps does not necessarily imply a strict execution sequence or impose any limitations on the implementation process. The specific execution sequence of each step should be determined based on its functionality and possible inherent logic.

Based on the same inventive concept, an embodiment of the present disclosure also provides a comic image generation apparatus corresponding to the comic image generation method. Since the principle of solving problems by the apparatus in the embodiment of the present disclosure is similar to the above-mentioned comic image generation method, the implementation of the method can be used as a reference for the implementation of the device, which will not be repeated here.

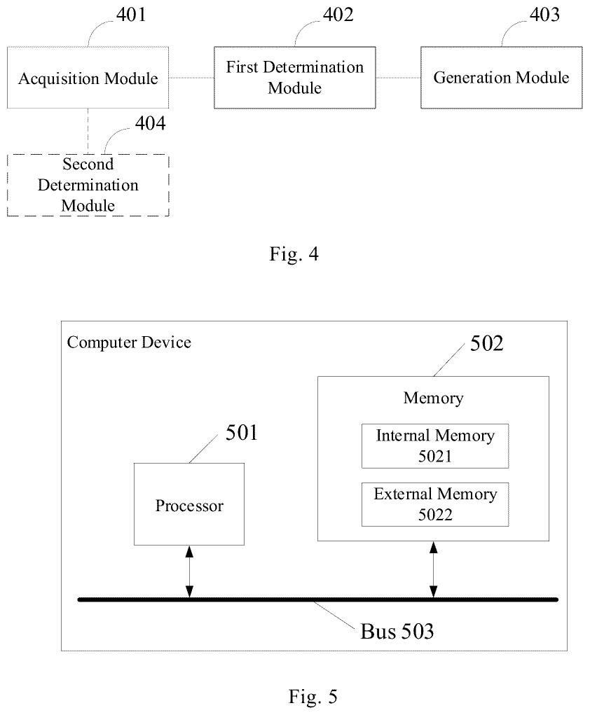

As shown in FIG. 4, which is a schematic diagram of a comic image generation apparatus according to an embodiment of the present disclosure, the apparatus includes:
an acquisition module 401, configured to acquire pose text information corresponding to a comic storyboard, the pose text information being used for describing target action poses of at least one target object;
a first determination module 402, configured to determine a pose assistance image corresponding to the comic storyboard according to the pose text information, reference action poses of a reference object in the pose assistance image matching the target action poses; and
a generation module 403, configured to generate comic images corresponding to the comic storyboard using an artificial intelligence model according to the pose text information and the pose assistance image, target objects in the comic images having the target action poses.

In a possible implementation, the apparatus further includes:
a second determination module 404, configured to determine the pose text information according to the following steps:
acquiring a target novel to be converted into a comic;
splitting the target novel according to novel content of the target novel to obtain comic text information of each comic storyboard corresponding to the target novel, the comic text information containing text keywords of the comic storyboard under multiple image generation dimensions; and
generating the pose text information corresponding to the comic storyboard according to the text keywords in the comic text information.

In a possible implementation, the second determination module 404, when generating the pose text information corresponding to the comic storyboard according to the text keywords in the comic text information, is configured to:
screen out at least one target keyword related to the target action poses of the target object from the text keywords; and
generate the pose text information according to at least one target keyword.

In a possible implementation, the first determination module 402, when determining the pose assistance image corresponding to the comic storyboard according to the pose text information, is configured to:
search for the pose assistance image matching the target action poses of at least one target object from a picture information library according to the pose text information and/or the text keywords corresponding to the pose text information.

In a possible implementation, the generation module 403, when generating comic images corresponding to the comic storyboard using the artificial intelligence model according to the pose text information and the pose assistance image, is configured to:
in response to the existence of an object generation model matching the target object, call the object generation model to obtain a target object image;
perform image recognition on the pose assistance image using a pose recognition model to obtain the reference action poses; and
generate the comic images using the artificial intelligence model according to the target object image, the reference action poses, and the pose text information.

In a possible implementation, the pose assistance image includes a skeletal point image; and
the first determination module 402, when determining the pose assistance image corresponding to the comic storyboard according to the pose text information, is configured to:
acquire an initial three-dimension (3D) skeletal point model;
perform pose adjustment on the initial 3D skeletal point model according to the target action poses of at least one target object to obtain a target 3D skeletal point model corresponding to each target object; and
determine the skeletal point image according to the target 3D skeletal point model.

In a possible implementation, the target action poses include a first action pose of the target object and a second action pose when the target object interacts with props; the reference action poses include a first reference pose matching the first action pose and a second reference pose matching the second action pose; and
the generation module 403, when generating comic images corresponding to the comic storyboard using the artificial intelligence model according to the pose text information and the pose assistance image, is configured to:
perform skeletal point recognition on the reference object in the pose assistance image using an artificial intelligence model by calling a skeletal point recognition function, to obtain the first reference pose, and performing contour recognition on the reference object in the pose assistance image by calling a contour recognition function, to determine the second reference pose; and
generate the comic images corresponding to the comic storyboard according to the first reference pose, the second reference pose and the pose text information, in which the target objects in the comic image have the first action pose and the second action pose.

In a possible implementation, the first determination module 402, when determining the pose assistance image corresponding to the comic storyboard according to the pose text information, is configured to:
determine pose types of the target action poses described in the pose text information,
determine the pose assistance image according to the pose text information in a case where the pose types meet a preset type condition, in which the preset type condition is used for indicating a pose type that the target action poses need to conform to when the pose assistance image needs to be used.

In a possible implementation, the acquisition module 401 is further configured to:
acquire background text information corresponding to the comic storyboard, the background text information being used for indicating a target image background corresponding to the comic storyboard;
the generation module 403, when generating comic images corresponding to the comic storyboard using the artificial intelligence model according to the pose text information and the pose assistance image, is configured to:
generate the comic images using the artificial intelligence model according to the pose text information, the pose assistance image, and the background text information, in which the target objects in the comic image have the target action poses and the comic images have the target image background.

For the process flow of each module in the apparatus and the interactive process between modules, please refer to the relevant description in the above method embodiment, which will not be repeated here.

Based on the same technical concept, an embodiment of the present disclosure also provides a computer device. Referring to FIG. 5 which is a structural schematic diagram of a computer device according to an embodiment of the present disclosure, the computer device includes:
a processor 501, a memory 502 and a bus 503. The memory 502 stores machine-readable instructions executable by the processor 501, the processor 501 is used for executing the machine-readable instructions stored in the memory 502, and when the machine-readable instructions are executed by the processor 501, the processor 501 executes the following steps: S101, acquiring pose text information corresponding to a comic storyboard, the pose text information being used for describing target action poses of at least one target object; S102, determining a pose assistance image corresponding to the comic storyboard according to the pose text information, reference action poses of a reference object in the pose assistance image matching the target action poses; and S103, generating comic images corresponding to the comic storyboard using an artificial intelligence model according to the pose text information and the pose assistance image, target objects in the comic image having the target action poses.

The memory 502 includes an internal memory 5021 and an external memory 5022. Here, the internal memory 5021, also called internal storage, is used for temporarily storing operation data in the processor 501 and data exchanged with the external memory 5022 such as a hard disk. The processor 501 exchanges data with the external memory 5022 through the internal memory 5021. When the computer device runs, the processor 501 communicates with the memory 502 through the bus 503, so that the processor 501 executes the instructions mentioned in the above method embodiment.

An embodiment of the present disclosure also provides a computer-readable storage medium, on which a computer program is stored, and when the computer program is run by a processor, the steps of the comic image generation method described in the above method embodiment are executed. The storage medium may be a volatile or nonvolatile computer-readable storage medium.

A computer program product of the comic image generation method provided by an embodiment of the present disclosure includes a computer-readable storage medium in which a program code is stored, and the program code includes instructions that can be used to execute the steps of the comic image generation method described in the above method embodiment. For details, please refer to the above-mentioned method embodiment, which is not repeated here.

The above computer program product can be implemented through hardware, software, or their combination. In one alternative embodiment, the computer program product is embodied as a computer storage medium, and in another alternative embodiment, the computer program product is embodied as a software product, such as a Software Development Kit (SDK).

It can be clearly understood by those skilled in the art that for the convenience and conciseness of description, to understand the specific working process of the system and apparatus described above, one can refer to the corresponding process in the aforementioned method embodiment, which will not be repeated here. In several embodiments provided by the present disclosure, it should be understood that the disclosed system, apparatus and method can be realized in other ways. The apparatus embodiment described above is only schematic. For example, the division of the units is only a logical function division, and there may be other division methods in actual implementation. For another example, multiple units or components may be combined or integrated into another system, or some features may be ignored or not implemented. Furthermore, the displayed or discussed coupling or direct coupling or communication can be indirect coupling or communication through some communication interfaces, apparatuses, or units, which can be electrical, mechanical, or in other forms.

The above-mentioned units illustrated as separate components may be, or may not be physically separated, and the components displayed as units may be, or may not be, physical units, that is, they may be at one place, or may also be distributed to a plurality of network units; and some or all of the units may be selected according to actual needs to achieve the purpose of the solutions of the present embodiment.

In addition, the respective functional units in the respective embodiments of the present disclosure may be integrated in one processing unit, or each unit may physically exist separately, or two or more units may be integrated in one unit.

In the case where the integrated unit is implemented in a form of software functional unit and sold or used as an independent product, the integrated unit may be stored in a computer readable storage medium. Based on such understanding, the technical solutions of the present disclosure, in essence, or the part that contributes to the prior art, or all or part of the technical solutions, may be embodied in a form of a software product; the computer software product is stored in a storage medium and includes several instructions so that a computer device (which may be a personal computer, a server, or a network device, etc.) to execute all or part of steps of the methods according to the respective embodiments of the present disclosure. The foregoing storage medium includes a USB flash disk, a removable hard disk, a Read-Only Memory (ROM), a Random Access Memory (RAM), a magnetic disk or an optical disk, and various other media that can store program codes.

If the technical scheme of the present disclosure involves personal information, the products applying the technical scheme of the present disclosure should clearly inform the rules for personal information processing and obtain the individual's voluntary consent before processing personal information. If the technical scheme of the present disclosure involves sensitive personal information, the products applying the technical scheme of the present disclosure should secure individual separate consent before processing such sensitive personal information, and simultaneously meet the criteria for “explicit consent”. For instance, at personal information collection devices such as cameras, clear and conspicuous signs should be placed to inform individuals that they have entered the range of personal information collection, and that their personal information will be collected. If individuals voluntarily enter the collection range, it will be considered as consent to the collection of their personal information. Alternatively, on devices for personal information processing, individual authorization can be obtained by using conspicuous signs/information to inform individuals of the rules for personal information processing, via pop-up messages, or by requesting individuals to upload their personal information themselves, and so on. The rules for personal information processing may include the personal information processor, the purpose of personal information processing, the processing methods, the types of personal information being processed, and other information.

Finally, it should be noted that the above-mentioned embodiments are only concrete implementations of the present disclosure, which are used to illustrate the technical scheme of the present disclosure, but not to limit it. The protection scope of the present disclosure is not limited to these embodiments. Although the present disclosure has been described in detail with reference to the above-mentioned embodiments, it should be understood by those of ordinary skill in the art that any technician familiar with the technical field can still modify or easily think of changes to the technical scheme recorded in the above-mentioned embodiments within the technical scope of the present disclosure, or equivalently replace certain technical features described in the aforementioned embodiments. These modifications, changes or substitutions do not make the essence of the corresponding technical scheme deviate from the spirit and scope of the technical scheme of the embodiments of the present disclosure, and should be included in the protection scope of the present disclosure. Therefore, the scope of protection of the present disclosure should be based on the scope of protection of the claims.

1. A comic image generation method, comprising:
acquiring pose text information corresponding to a comic storyboard, the pose text information being used for describing target action poses of at least one target object;
determining a pose assistance image corresponding to the comic storyboard according to the pose text information, reference action poses of a reference object in the pose assistance image matching the target action poses; and
generating comic images corresponding to the comic storyboard using an artificial intelligence model according to the pose text information and the pose assistance image, target objects in the comic images having the target action poses.

2. The method according to claim 1, wherein determining the pose text information comprises:
acquiring a target novel to be converted into a comic;
splitting the target novel according to novel content of the target novel to obtain comic text information of each comic storyboard corresponding to the target novel, the comic text information containing text keywords of the comic storyboard under multiple image generation dimensions; and
generating the pose text information corresponding to the comic storyboard according to the text keywords in the comic text information.

3. The method according to claim 2, wherein the generating the pose text information corresponding to the comic storyboard according to the text keywords in the comic text information comprises:
screening out at least one target keyword related to the target action poses of the target object from the text keywords; and
generating the pose text information according to at least one target keyword.

4. The method according to claim 2, wherein the determining the pose assistance image corresponding to the comic storyboard according to the pose text information comprises:
searching for the pose assistance image matching the target action poses of at least one target object from a picture information library according to the pose text information and/or the text keywords corresponding to the pose text information.

5. The method according to claim 1, wherein the generating comic images corresponding to the comic storyboard using the artificial intelligence model according to the pose text information and the pose assistance image comprises:
in response to the existence of an object generation model matching the target object, calling the object generation model to obtain a target object image;
performing image recognition on the pose assistance image using a pose recognition model to obtain the reference action poses; and
generating the comic images using the artificial intelligence model according to the target object image, the reference action poses, and the pose text information.

6. The method according to claim 1, wherein the pose assistance image comprises a skeletal point image; and
the determining the pose assistance image corresponding to the comic storyboard according to the pose text information comprises:
acquiring an initial three-dimension (3D) skeletal point model;
performing pose adjustment on the initial 3D skeletal point model according to the target action poses of at least one target object to obtain a target 3D skeletal point model corresponding to each target object; and
determining the skeletal point image according to the target 3D skeletal point model.

7. The method according to claim 1, wherein the target action poses comprise a first action pose of the target object and a second action pose when the target object interacts with props; the reference action poses comprise a first reference pose matching the first action pose and a second reference pose matching the second action pose; and
the generating comic images corresponding to the comic storyboard using the artificial intelligence model according to the pose text information and the pose assistance image comprises:
performing skeletal point recognition on the reference object in the pose assistance image using an artificial intelligence model by calling a skeletal point recognition function, to obtain the first reference pose, and performing contour recognition on the reference object in the pose assistance image by calling a contour recognition function, to determine the second reference pose; and
generating the comic images corresponding to the comic storyboard according to the first reference pose, the second reference pose and the pose text information, wherein the target objects in the comic image have the first action pose and the second action pose.

8. The method according to claim 1, wherein the determining the pose assistance image corresponding to the comic storyboard according to the pose text information comprises:
determining pose types of the target action poses described in the pose text information; and
determining the pose assistance image according to the pose text information in a case where the pose types meet a preset type condition, wherein the preset type condition is used for indicating a pose type that the target action poses need to conform to when the pose assistance image needs to be used.

9. The method according to claim 1, further comprising:
acquiring background text information corresponding to the comic storyboard, the background text information being used for indicating a target image background corresponding to the comic storyboard;
wherein the generating comic images corresponding to the comic storyboard using the artificial intelligence model according to the pose text information and the pose assistance image comprises:
generating the comic images using the artificial intelligence model according to the pose text information, the pose assistance image, and the background text information,
wherein the target objects in the comic image have the target action poses and the comic images have the target image background.

10. A computer device, comprising a processor and a memory, wherein the memory stores machine-readable instructions executable by the processor, the processor is used for executing the machine-readable instructions stored in the memory, and when the machine-readable instructions are executed by the processor, the processor executes a comic image generation method, which comprises:
acquiring pose text information corresponding to a comic storyboard, the pose text information being used for describing target action poses of at least one target object;
determining a pose assistance image corresponding to the comic storyboard according to the pose text information, reference action poses of a reference object in the pose assistance image matching the target action poses; and
generating comic images corresponding to the comic storyboard using an artificial intelligence model according to the pose text information and the pose assistance image, target objects in the comic images having the target action poses.

11. The computer device according to claim 10, wherein determining the pose text information comprises:
acquiring a target novel to be converted into a comic;
splitting the target novel according to novel content of the target novel to obtain comic text information of each comic storyboard corresponding to the target novel, the comic text information containing text keywords of the comic storyboard under multiple image generation dimensions; and
generating the pose text information corresponding to the comic storyboard according to the text keywords in the comic text information.

12. The computer device according to claim 11, wherein the generating the pose text information corresponding to the comic storyboard according to the text keywords in the comic text information comprises:
screening out at least one target keyword related to the target action poses of the target object from the text keywords; and
generating the pose text information according to at least one target keyword.

13. The computer device according to claim 11, wherein the determining the pose assistance image corresponding to the comic storyboard according to the pose text information comprises:
searching for the pose assistance image matching the target action poses of at least one target object from a picture information library according to the pose text information and/or the text keywords corresponding to the pose text information.

14. The computer device according to claim 10, wherein the generating comic images corresponding to the comic storyboard using the artificial intelligence model according to the pose text information and the pose assistance image comprises:
in response to the existence of an object generation model matching the target object, calling the object generation model to obtain a target object image;
performing image recognition on the pose assistance image using a pose recognition model to obtain the reference action poses; and
generating the comic images using the artificial intelligence model according to the target object image, the reference action poses, and the pose text information.

15. The computer device according to claim 10, wherein the pose assistance image comprises a skeletal point image; and
the determining the pose assistance image corresponding to the comic storyboard according to the pose text information comprises:
acquiring an initial three-dimension (3D) skeletal point model;
performing pose adjustment on the initial 3D skeletal point model according to the target action poses of at least one target object to obtain a target 3D skeletal point model corresponding to each target object; and
determining the skeletal point image according to the target 3D skeletal point model.

16. The computer device according to claim 10, wherein the target action poses comprise a first action pose of the target object and a second action pose when the target object interacts with props; the reference action poses comprise a first reference pose matching the first action pose and a second reference pose matching the second action pose; and
the generating comic images corresponding to the comic storyboard using the artificial intelligence model according to the pose text information and the pose assistance image comprises:
performing skeletal point recognition on the reference object in the pose assistance image using an artificial intelligence model by calling a skeletal point recognition function, to obtain the first reference pose, and performing contour recognition on the reference object in the pose assistance image by calling a contour recognition function, to determine the second reference pose; and
generating the comic images corresponding to the comic storyboard according to the first reference pose, the second reference pose and the pose text information, wherein the target objects in the comic image have the first action pose and the second action pose.

17. The computer device according to claim 10, wherein the determining the pose assistance image corresponding to the comic storyboard according to the pose text information comprises:
determining pose types of the target action poses described in the pose text information; and
determining the pose assistance image according to the pose text information in a case where the pose types meet a preset type condition, wherein the preset type condition is used for indicating a pose type that the target action poses need to conform to when the pose assistance image needs to be used.

18. The computer device according to claim 10, wherein the method further comprises:
acquiring background text information corresponding to the comic storyboard, the background text information being used for indicating a target image background corresponding to the comic storyboard;
wherein the generating comic images corresponding to the comic storyboard using the artificial intelligence model according to the pose text information and the pose assistance image comprises:
generating the comic images using the artificial intelligence model according to the pose text information, the pose assistance image, and the background text information,
wherein the target objects in the comic image have the target action poses and the comic images have the target image background.

19. A non-transitory computer-readable storage medium, wherein a computer program is stored on the non-transitory computer-readable storage medium, and when the computer program is run on a computer device, the computer device executes a comic image generation method, which comprises:
acquiring pose text information corresponding to a comic storyboard, the pose text information being used for describing target action poses of at least one target object;
determining a pose assistance image corresponding to the comic storyboard according to the pose text information, reference action poses of a reference object in the pose assistance image matching the target action poses; and
generating comic images corresponding to the comic storyboard using an artificial intelligence model according to the pose text information and the pose assistance image, target objects in the comic images having the target action poses.

20. The non-transitory computer-readable storage medium according to claim 19, wherein determining the pose text information comprises:
acquiring a target novel to be converted into a comic;
splitting the target novel according to novel content of the target novel to obtain comic text information of each comic storyboard corresponding to the target novel, the comic text information containing text keywords of the comic storyboard under multiple image generation dimensions; and
generating the pose text information corresponding to the comic storyboard according to the text keywords in the comic text information.
